(19) United States
(12) Patent Application Publication
(10) Pub. No.: US 2022/0108353 A1
(43) Pub. Date: Apr. 7, 2022

(54) DIGITAL CONSUMER IDENTIFICATION IN A SUPPLY CHAIN

(71) Applicant: Catalina Marketing Corporation, St. Petersburg, FL (US)

(72) Inventors: Wassim Samir CHAAR, Coppell, TX (US); Zubin SINGH, Cupertino, CA (US); Kevin HUNTER, La Jolla, CA (US)

(21) Appl. No.: 17/429,595

(22) PCT Filed: Feb. 11, 2020
(86) PCT No.: PCT/US2020/017784

§ 371 Date: Aug. 9, 2021

Related U.S. Application Data
(60) Provisional application No. 62/803,860, filed on Feb. 11, 2019.

(51) Int. Cl. G06Q 30/02; G06F 16/29; G06F 16/2457

(52) U.S. Cl. CPC G06Q 30/0261; G06F 16/29; G06Q 30/0269; G06Q 30/0267; G06F 16/2457; G06Q 30/0201

(57) ABSTRACT

A method is provided that includes collecting a first party data from a client device associated with a consumer and storing the first party data in a database. The method also includes comparing the first party data with a second party data in the database to identify a consumer profile associated with the first party data and with the second party data and providing, to the client device, a digital advertisement based on the consumer profile in the database and on the first party data. A system for performing the above method is also provided.

### CROSS-REFERENCE TO RELATED APPLICATIONS

The present disclosure is related to and claims priority under the rules and regulations of the WIPO Patent Cooperation Treaty to U.S. Provisional Patent Application No. 62/803,860, entitled “DIGITAL CONSUMER IDENTIFICATION IN A SUPPLY CHAIN,” to Wassim Samir CHAAR et al., filed on Feb. 11, 2019, the contents of which are herein incorporated by reference in their entirety, for all purposes.

### BACKGROUND

### Field

The present disclosure generally relates to systems and procedures for identifying consumers using a variety of first and second party data sets comingled and joined with existing household and consumer identification graphs stored in a server database (e.g., for marketing purposes). More specifically, embodiments as disclosed herein relate to identifying a consumer using probabilistic techniques involving consumer interest data, geolocation data, demographic data, personality data, media consumption data, iAB supply categorization data, digital signals, and the like, that help create a robust profile of a consumer over time. The consumer profile can eventually be used to cluster and target consumers with digital advertising campaigns.

### Description of the Related Art

Current digital advertising and marketing techniques use piecemeal information gathered from consumers who typically subscribe to specific network services. This leads to loss of marketing opportunities or even a wasteful use of advertising resources when the wrong target is addressed.

### SUMMARY

In one embodiment, a computer-implemented method is provided that includes collecting a first party data from a client device associated with a consumer and storing the first party data in a database. The computer-implemented method also includes comparing the first party data with a second party data in the database to identify a consumer profile associated with the first party data and with the second party data and providing, to the client device, a digital advertisement based on the consumer profile in the database and on the first party data.

In a second embodiment, a computer-implemented method is disclosed that includes requesting, from a client device to a first server hosting a consumer network, a digital value added certificate, the client device being associated with a consumer that subscribes to the consumer network. The computer-implemented method also includes providing, to the first server, a first party data from the client device. The first party data is correlated to a second party data in a database accessible to the first server and at least one of the first party data or the second party data comprises a geolocation information indicative of a presence of the consumer within a radius from a retail store. The first server is configured to identify a consumer profile associated with the first party data and with the second party data and to generate the digital value added certificate for the consumer based on a likelihood that the geolocation information corresponds to the consumer profile. The computer-implemented method also includes receiving, in the client device, the digital value added certificate and validating the digital value added certificate at a point of sale in the retail store.

In yet another embodiment, a system is disclosed that includes a memory circuit storing instructions and one or more processors. The one or more processors are configured to execute at least one instruction to cause the system to collect a first party data from a client device associated with a consumer and to store the first party data in a database. The one or more processors also execute instructions to compare the first party data with a second party data in the database to identify a consumer profile associated with the first party data and with the second party data, and to provide, to the client device, a digital advertisement based on the consumer profile in the database and on the first party data.

### BRIEF DESCRIPTION OF THE DRAWINGS

FIG. 1 illustrates a system configured for digital consumer identification in a supply chain, according to some embodiments.

FIG. 2 illustrates an example architecture suitable for implementing the system in FIG. 1, according to some embodiments.

FIG. 3 illustrates a table in a database for cross correlating multiple columns including a loyalty card ID with second party sourced data, according to some embodiments.

FIG. 4 illustrates a graph correlating multiple household identifiers and digital identifiers in a database, according to some embodiments.

FIG. 5 is a flowchart including steps in a method for identifying consumers using first party owned and second party sourced datasets, according to some embodiments.

FIG. 6 is a flowchart including steps in a method for providing a digital advertisement to a consumer upon identification of the consumer in a database, according to some embodiments.

FIG. 7 is a flowchart including steps in a method for requesting a digital value added certificate to a server hosting a consumer network, according to some embodiments.

FIG. 8 illustrates a block diagram illustrating an example computer system with which the client and network device of FIG. 1 and the methods of FIGS. 5-7 can be implemented, according to some embodiments.

In the figures, elements labeled with the same or similar reference numerals may have similar functionality and features, unless stated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

A system as provided herein is configured to collect a variety of first and second party datasets like consumer interest data, geolocation data, demographic data, personality data, media consumption data, iAB supply categorization data, digital signals, and the like, to store the information in a database, to run a variety of data science techniques and procedures to cluster and resolve unknown consumer identities from within the existing household and consumer identification graphs in a probabilistic manner, and to provide the capability to target the resolved consumer identity profiles in the digital space. In some embodiments, systems as disclosed herein may operate in the context of a consumer located inside a retail store, or at a point of sale (POS) for the retail store.

Embodiments as disclosed herein provide a solution to the problem arising in the realm of computer technology for developing advertising models directed to targeted payloads over large populations of consumers. Tools disclosed herein provide the technical ability to precisely identify a consumer or a group of consumers from digital information collected by multiple parties in a centralized database.

The subject systems and methods provide several advantages, including the display of data in correlated tables and graphs. The proposed solution further provides improvements to the functioning of the computer itself, because it can reduce processing time for finding correlations and identifying consumer patterns and networks. Additionally, the subject system decreases a burden on a computer processor, network hardware and resources, and/or device power for performing the correlations and updating models across one or more components of a system, resulting in improvements that may be realized in an observable manner

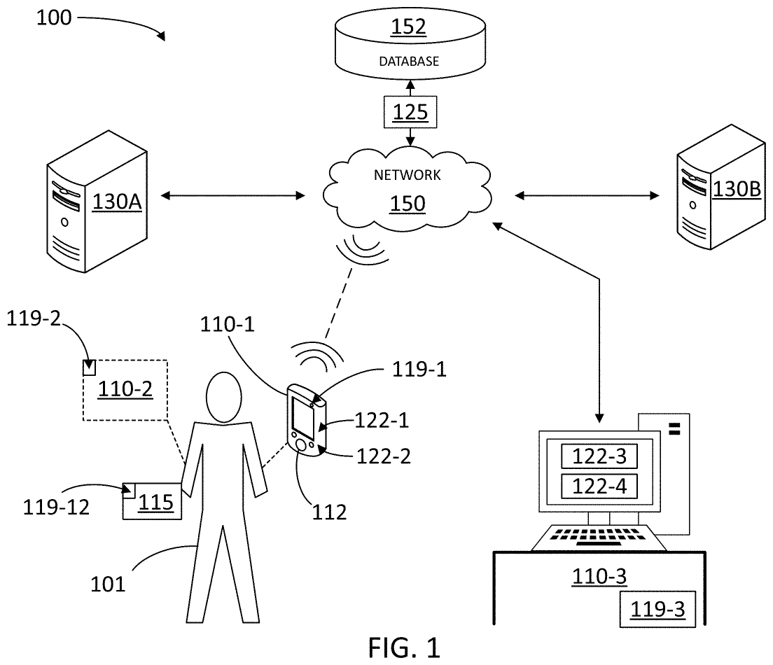

FIG. 1 illustrates a system 100 configured for identifying a consumer 101 using geolocation data and other digital identification data collected in a network 150. System 100 includes a server 130A, a server 130B (hereinafter, collectively referred to as “servers 130”), a database 152, and client devices 110-1, 110-2, and 110-3 (hereinafter, collectively referred to as “client devices 110”). In some embodiments, client devices 110 include internet enabled devices such as a mobile device 110-1, a tablet device 110-2, a household computer 110-3, and other appliances such as television sets, and any other sensors and devices, through network 150. Client devices 110, severs 130, and database 152 may be communicatively coupled with one another wirelessly (e.g., cellular network, WiFi, BlueTooth, and the like) or through a wired channel (e.g., telephone line, Ethernet, and the like). Client devices 110, servers 130, and database 152 may each include at least a memory circuit and one or more processor circuits. The memory circuits may include instructions which, when executed by the processor circuits, cause the devices, servers A and B, and the database to perform at least some steps in methods as disclosed herein.

Client devices 110 may include one or more applications 122 such as application programming interfaces (APIs) or software development kits (SDKs) hosted by any one of servers 130. Without limitation, multiple servers 130 may host multiple APIs or SDKs installed in the devices, providing different network services to consumer 101. For example, server 130B may be a network publishing host, providing multimedia content to consumer 101, for downstream (e.g., news and entertainment, services, and the like). In some embodiments, server 130B may host mapping and other geolocation services to the consumer (e.g., applications 122-1 and 122-2, through a GPS device 112 in smart phone 110-1). Likewise, client device 110-3 may be a desktop computer running application 122-3 (API) and/or an application 122-4 (SDK). More generally, servers 130 may provide any network service to consumer 101 including retail shopping, consumer brands, services, information, entertainment, travel, business, and the like.

Consumer 101 may have a loyalty card 115 including a loyalty card ID 119-12, with membership to a network service hosted by server A. In some embodiments, client devices 110 or applications 122 may include personal identifiable information (PII) such as an advertising digital identifier 119-1, a device identifier 119-2, an IP address 119-3, or any other ID naming scheme that is PII-safe, following the guidelines set forth by the iAB. Hereinafter, advertising digital identifier 119-1, device identifier 119-2, or IP address 119-3 will be collectively referred to as “digital identifiers 119.” In some embodiments, consumer 101 may be located within a retail store (e.g., in a particular section of the store, aisle, or kiosk) or even at a point of sale (POS) of the retail store, and servers 130 may be able to retrieve digital identifiers 119 for use as in methods disclosed herein.

Database 152 may include a PII safe database and may store information 125 about consumer 101. In some embodiments, information 125 may include digital identifiers 119 and other consumer information gathered by any one of applications 122. Database 152 may include one or more databases accessible to at least one of servers 130 through network 150. In some embodiments, servers 130 may include their own database, coupled to the network through a firewall configured to provide privacy and security to the information.

In some embodiments and without limitation, GPS device 112 may provide latitude and longitude coordinates of client device 110-1 to API 122-1 or SDK 122-2 running in memory. Either one of servers 130, or both, may collect the geolocation of mobile device 110-1, including other technographic information specific to the device (IP address, device operating system, “user-agent,” and the like), information about application 122 or website that consumer 101 is running, and other PII safe contextual information. Server 130 may also store digital identifiers 119 and other information 125 in database 152 upon consent and agreement by consumer 101.

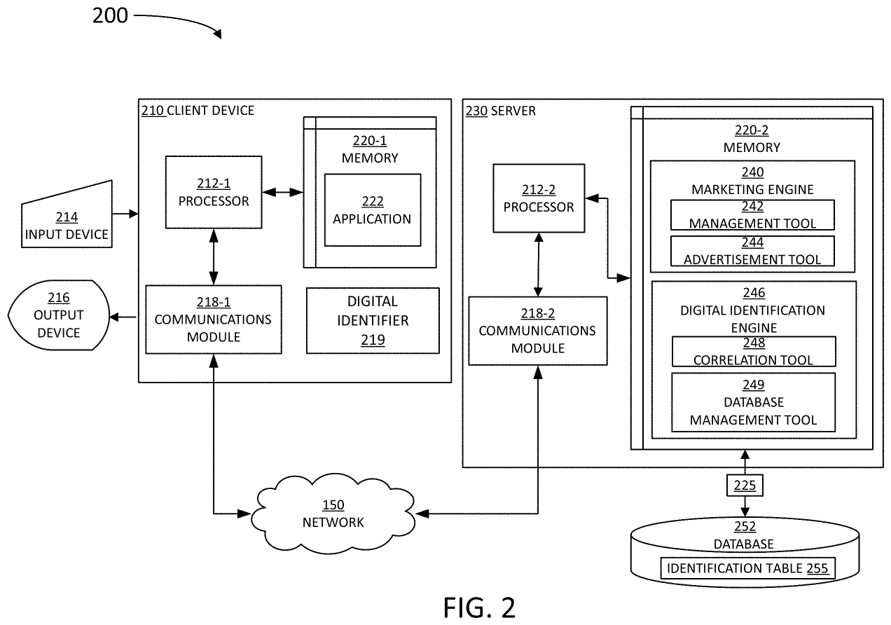

FIG. 2 illustrates an example architecture 200 suitable for implementing the system in FIG. 1, according to some embodiments. A client device 210 is communicatively coupled with a server 230 via network 150. Server 230 may also have access to a database 252 via network 150. In some embodiments, database 252 may be part of server 230. While architecture 200 only shows one server 230 and one client device 210, in some embodiments, multiple client devices may couple to multiple servers through network 150, of which client device 210 and server 230 are but one example. Client device 210 may include a personal computer, a portable or mobile computer (e.g., a laptop), a cell phone, a smartphone, a palm device, or any other device such as a printer, a smart printer, or a display (e.g., client devices 110). Client device 210 may also include or be communicatively coupled with one or more peripheral devices such as an input device 214 and an output device 216. In some embodiments, input device 214 includes any one of a touch screen, a stylus, a mouse, a keyboard, or a microphone. Likewise, output device 216 may include a display, a speaker, and the like.

Client device 210 and server 230 may include a processor 212-1 and a memory 220-1 (client device 210), a processor 212-2 and a memory 220-2 (server 230), hereinafter, collectively referred to as “processors 212” and “memories 220.” A communications module 218-1 in client device 210 and a communications module 218-2 in server 230 enable interfacing each of these devices with network 150 (hereinafter, collectively referred to as “communications modules 218”). Communications modules 218 may include radio frequency circuitry and antennas configured to transmit and receive radio frequency signals such as Bluetooth, near field coupling, Wi-Fi, and the like. In that regard, communications modules 218 may enable one or more client devices as client device 210 and one or more servers as server 230 to communicate to one another directly, separately from network 150.

Database 252 may include an identification table 255. In some embodiments, identification table 255 may include a correlation table associating digital identifier 219 with a consumer purchasing history for multiple devices 210 and multiple consumers. In some embodiments, table 355 is a correlation table between multiple digital data sources. Database 252 may also include information from retail stores and brand manufacture products.

Memory 220-1 may include an application 222 (e.g., APIs, SDKs, and the like, cf. applications 122) including instructions which, when executed by processor 212-1, cause client device 210 to execute at least partially some of the methods disclosed herein. In some embodiments, application 222 may be installed and hosted by server 230 upon consumer authorization. Likewise, memory 220-2 may include a marketing engine 240 and a digital identification engine 246 having instructions which, when executed by processor 212-2, cause server 230 to execute at least partially some of the methods consistent with the present disclosure. Client device 210 may also include a digital identifier 219 associated with the device and/or a digital identification number in application 222 (e.g., digital identifier 119).

Marketing engine 240 performs marketing analysis and devises advertisement campaign strategies as well as promotional offers to consumers in view of business rules, advertisement rules, and consumer profiles. In some embodiments, marketing engine 240 includes a management tool 242 and an advertisement tool 244. In some embodiments, management tool 242 includes analytics algorithms based on business rules. In some embodiments, advertisement tool 244 includes algorithms based on campaign rules, campaign management, campaign optimization, campaign analytics, and handling campaign errors. In some embodiments, marketing engine 240 includes identity resolution algorithms, and is configured to perform identity mapping and onboarding of new subscribers. In some embodiments, marketing engine 240 includes installing and updating digital platform adaptors and interfaces for client device 210, including application 222 and devices related thereof (e.g., GPS device 112).

Digital identification engine 246 may include a correlation tool 248 and a database management tool 249. In some embodiments, correlation tool 248 includes techniques and procedures in the field of data science to probabilistically identify consumers for the purposes of targeting relevant and engaging advertising media, based on digital identifier 219 and identification table 255. Database management tool 249 may create and update identification table 255 and digital identifier 219 from multiple client devices 210 compiled into a digital information 225.

In some embodiments, correlation tool 248 and database management tool 249 may collect and aggregate data from one or more servers 230 (e.g., a first party data, a second party data, a third party data, and the like). In some embodiments, at least one of the first party data or the second party data includes digital identifier 219, and correlation tool 248 compares the first party data with the second party data to determine a likelihood that client device 210 is used by a consumer associated with the consumer profile in database 252. In some embodiments, correlation tool 248 correlates at least one of an internet protocol address, an operating system version in the client device, a user agent, an application, or a website running in the client device (e.g., in application 222). In some embodiments, correlation tool 248 pairs the first party data and the second party data within a radius of a geolocation information associated with client device 210. In some embodiments, correlation tool 248 associates a consumer profile with a group of consumers having a household identifier. In some embodiments, correlation tool 248 determines the second party data based on at least a portion of the first party data with a model trained with a data stored in the database. In some embodiments, the first party data includes a mobility data for the client device, and correlation tool 248 infers the second party data with a behavioral model based on the mobility data. In some embodiments, digital identification engine 246 receives a purchasing data associated with a digital advertisement and with the consumer, and updates a model for comparing the first party data with the second party data based on the purchasing data. The model may include a neural network model, a machine learning model, an artificial intelligence model, and any type of multilinear regression model, nonlinear model, or linear model. In some embodiments, correlation tool 248 updates the consumer profile based on the first party data and the second party data. In some embodiments, correlation tool 248 determines a correlation between the consumer and the consumer profile and determining a confidence level for the correlation. In some embodiments, correlation tool 248 receives a third party data associated with the consumer and to update the database with the third party data to improve a likelihood that the consumer profile is associated with the consumer.

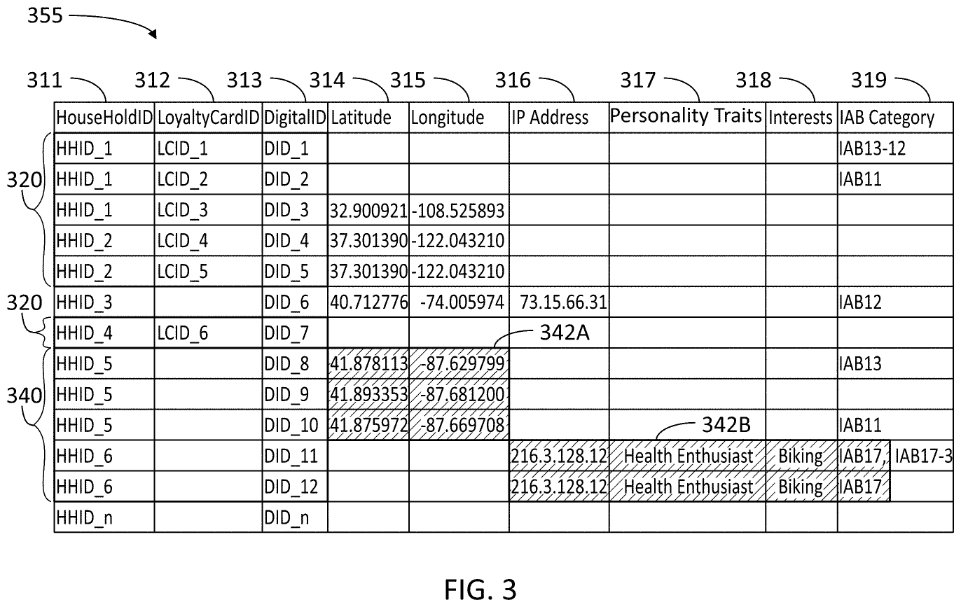

FIG. 3 illustrates a table 355 in a database for cross correlating multiple columns including a loyalty card ID with a second party sourced data (e.g., identification table 255 and database 252), according to some embodiments. Table 355 includes a database for cross correlating a household ID (HHID) column 311 with a Loyalty Card ID (LCID) column 312 and a Digital ID (DID) column 313 using a variety of first and second party source data, according to some embodiments. Without limitations, a location information (e.g., provided by a GPS device, cf. GPS device 112) may be included in a latitude column 314, a longitude column 315, and an IP address column 316. Table 355 may further include consumer information that may be sourced from other data sources that contain PII safe consumer information that can be retrieved from a third party server (e.g., bought or licensed). Consumer information may be included in a “personality traits” column 317, an “interests” column 318, and an “iAB category” column 319. In some embodiments, information in columns 317 through 319 may be provided by social networking servers that consumers may subscribe to, or by a machine learning algorithm, an artificial intelligence algorithm, operating on other digital data available for the consumer (e.g., any one of columns 314-316). Table 355 may be stored in a database and used by a digital identification engine (e.g., digital identification engine 246) to establish a correlation between the different columns in table 355 and a consumer identification.

In embodiments consistent with the present disclosure, table 355 is created or stored in a database coupled to a server (e.g., database 252 and server 230). The database collects information from a variety of devices and first and second party data sources (e.g., information 125 and 225) to correlate datasets and to enhance and create new consumer household, loyalty, and digital ID associations in no particular order. The correlation may include, for example, pairing together an entry in HHID column 311 with an entry in LCID column 312 and an entry in DID column 313, based on the same (or similar) entries for latitude column 314 and longitude column 315. For example, line 5 in table 355 indicates a consumer that logs into an account having LCID_5 (LCID column 312) in Server A, using a mobile device with DID_5 (DID column 313). The mobile device may further report a geolocation consistent with HHID_2 (latitude: 37.301390, longitude: −122.043210). In such case, the correlation between the HHID_2 value, the LCID_5 value, and the DID_5 value may be strong. That is, it is highly likely that the user of the mobile device with DID_5 also has loyalty card LCID_5 and lives within household HHID_2. Accordingly, lines 1 through 5 and 7 in table 355 may be associated with a deterministic match 320.

Note that, as expected, more than one consumer may be associated with a given entry in HHID column 311. For example, the household with HHID_2 includes at least two individuals having LCID_4 and LCID_5 in LCID column 312. Each individual uses a different mobile device, having DID_4 and DID_5, respectively (cf. DID column 313, 11. 4 and 5). The geolocation with latitude: 37.301390 and longitude: −122.043210 is presumably the home location for HHID_2. Further, the household with HHID_1 includes at least three individuals having LCID_L LCID_2, and LCID_3. Each individual uses a different mobile device, having DID_L DID_2, and DID_3, respectively. The geolocation with latitude: 37.900921 and longitude: −108.525893 may be the home location for HHID_1, or a retail store location, or any other location associated with the mobile device having DID_3. Note that, in the particular case of HHID_1, the precise location of HHID_1 may not be corroborated with DID_1 and DID_2 (e.g., no data in latitude column 314 or longitude column 315 for the first two lines in Table 355). For example, server A may not have had access to the geolocation of the mobile devices DID_1 and DID_2, but may still be able to correlate all to HHID-1, based on other information. The other information may include purchase patterns with the respective loyalty cards (based on the entries in LCID column 312): the items, the retailer locations, and the time of purchase, over an extended sampling period.

Table 355 may also include entries having a weaker correlation wherein the LCID value may be missing or not yet established and probabilistic match 340 may be used to link, join, and increase the correlation from one ID set to another (e.g., amongst either one of columns 311-319). This may be the case when a server (e.g., server 130A) accesses data and information for consumers that are not loyalty card network subscribers. Accordingly, in household HHID_5, consumers having mobile devices DID_8, DID_9, and DID_10 may be associated with geolocation (41.878113, −87.629799), (41.893353, −87.681200), and (41.875972, −87.669708), respectively (cf. lines 8-10 in Table 355). These geolocations, although different, are very close to each other (cf. data block 342A), which presumably indicates either the home address of HHID_5, or the address of a store or a mall where the different household members go shopping (e.g., at the same or overlapping times). However, in some embodiments, the difference between the geolocation of the household members in HHID_5 (which in this particular instance may amount to a few square km) may reduce the degree of certitude that these DIDs should be associated with HHID_5. Another probabilistic match may link two consumers with mobile devices DID_11 and DID_12 with household HHID_6, having an IP address 216.3.128.12 (cf. lines 11-12, block 342B in Table 355). For example, server A may have detected that both DID_11 and DID_12 log in to the network from IP address 216.3.128.12 late at night. Moreover, based on other information (gathered by server A from server B), both consumers in HHID_6 may be listed as health enthusiasts interested in biking (e.g., through purchase history, usual location at parks and outdoors, typical speed of motion at those locations, and the like).

Additionally, Table 355 may indicate that household HHID_3 may be linked with mobile device DID_6 (cf. line 6 in Table 355). However, whereas the geolocation (40.712776, −74.005974) and an IP address 73.15.66.31 have been established, the absence of a loyalty card to back up the data (e.g., no data in LCID column 312), or the lack of more household members, soften the degree of certitude that the correlation indicated in Table 355 be correct. In some embodiments, the availability of a correlation between the HHID value, the LCID value, and the DID value indicates a strong, deterministic match 320 between HHID_4, LCID_6, and DID_7, even in the absence of a geolocation, or an IP address, or any further consumer data, other than the iAB category (iAB12), which can be determined from the loyalty card account associated with LCID_6.

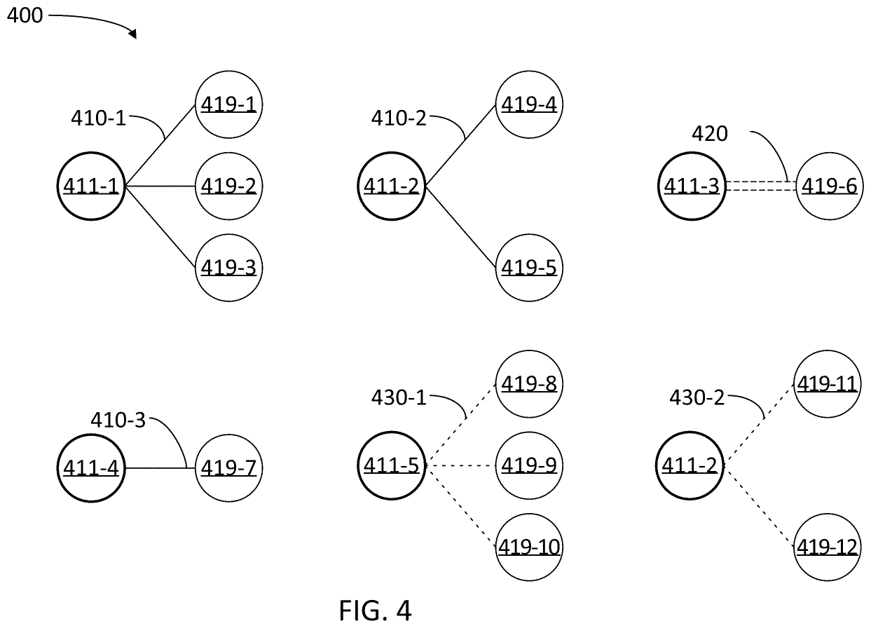

FIG. 4 illustrates a graph 400 correlating multiple household identifiers 411-1, 411-2, 411-3, 411-4, and 411-5 (hereinafter, collectively referred to as “household identifiers 411”) and digital identifiers 419-1, 419-2, 419-3, 419-4, 419-5, 419-6, 419-7, 419-8, 419-9, 419-10, 419-11, and 419-12 (hereinafter, collectively referred to as “digital identifiers 419”) in a database, according to some embodiments. Graph 400 includes a mapping correlation between multiple household identifiers 411 and digital identifiers 419 in a database (e.g., databases 152 and 252), according to some embodiments. In some embodiments, graph 400 may be obtained by a digital identification engine in a server from an identification table stored in a database (e.g., digital identification engine 246, servers 130, server 230, database 152, database 252, identification table 255, and table 355). Accordingly, graph 400 associates DID_1, DID_2, and DID_3 with HHID_1 through a strong and deterministic link 410-1. Likewise, DID_4 and DID_5 are associated with HHID_2 through strong, deterministic link 410-2, and DID_7 with HHID_4 through strong, deterministic link 410-3. Graph 400 also illustrates DID_8, DID_9, and DID_10 associated with HHID_5 through a probabilistic link 430-1 (with a high degree of certainty, as the similar geolocation of the three mobile devices DID_8-10 indicates, cf. Table 355). Also, DID_11 and DID_12 are associated with HHID_2 through a probabilistic link 430-2 (with a high degree of certainty, as the IP address associated with both devices is the same, and both consumers seem to have the same personality traits and share the same iAB category).

Graph 400 also illustrates a non-conclusive link 420 between DID 419-6 and HHID 411-3, (cf. Table 355), due to the missing information regarding the loyalty card. Note that in the case of HHID 411-3, even though a geolocation is established, in addition to an IP address, the absence of a second mobile device or consumer correlated with the same household reduces somewhat the degree of certitude that the link between HHID 411-3 and DID 419-6 is accurate.

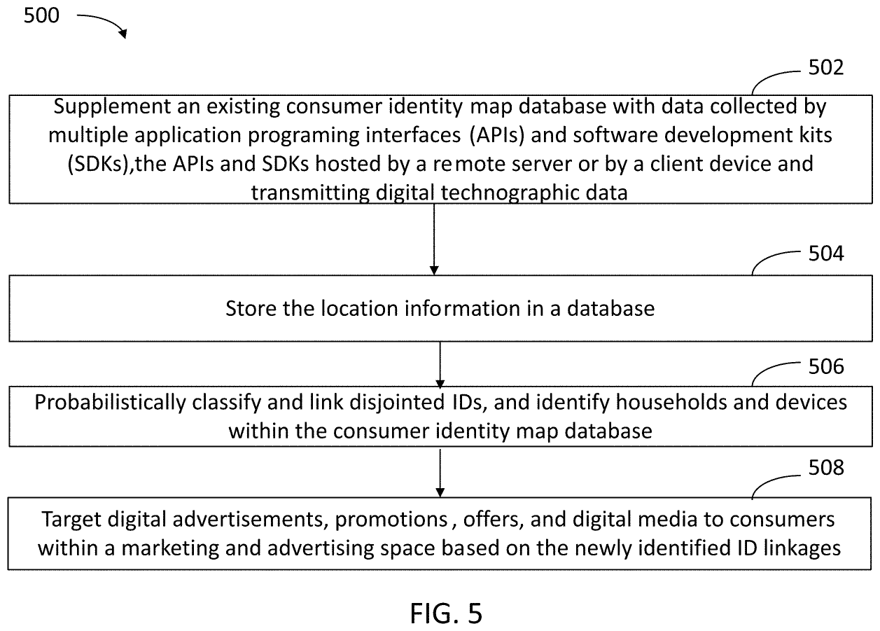

FIG. 5 is a flowchart including steps in a method 500 for identifying consumers using first party owned and second party sourced datasets, according to some embodiments. In some embodiments, one or more of the steps in method 500 may be performed by one or more of the devices and components illustrated in FIGS. 1 and 2. For example, in some embodiments, one or more of the steps in method 500 may be performed by a client device or a server including processors executing instructions stored in memory circuits (e.g., client devices 110 and 210, servers 130 and 230, and processors 212 and memories 220, cf. FIGS. 1, 2). In some embodiments, the memory may include a marketing engine having a management tool and an advertisement tool, and a digital identification engine having a correlation tool and a database management tool (e.g., marketing engine 240, management tool 242, advertisement tool 244, digital identification engine 246, correlation tool 248, and database management tool 249, cf. FIG. 2). In some embodiments, the server may also be communicatively coupled to a database storing digital information arranged in an identification table or any other tables and in a graph, via a network (e.g., databases 152 and 252, digital information 225, identification table 255, table 355, graph 400, and network 150, cf. FIGS. 1, 2, 3, and 4). In some embodiments, to communicate with each other and the network, the client devices and servers may execute steps consistent with method 500 using an input device, an output device, and a communications module (e.g., input device 214, output device 216, and communications module 218, cf. FIG. 2). Moreover, in some embodiments, methods consistent with the present disclosure may include at least one of the steps in method 500 performed in a different order, simultaneously, quasi-simultaneously, or overlapping in time.

Step 502 includes collecting information from devices where APIs and SDKs provide technographic and digital device data including second party sourced datasets that provide consumer interest data, geolocation data, demographic data, personality data, media consumption data, iAB supply categorization data, digital signals, and the like. In some embodiments, step 502 includes supplementing an existing consumer identity map database with the above collected data.

Step 504 includes storing the gathered location information in a database. In some embodiments, step 504 is performed by an application programming interface installed in the devices, and step 504 includes accessing the application programming interface with a second application programming interface installed in the devices referenced in FIG. 1. Without limitation, in some embodiments, step 504 includes storing an identifier of the device IDs in the database, and wherein comparing second party sourced information with a consumer profile in the database includes matching the identifier of the devices with a consumer household identifier in the database.

Step 506 includes running a set of analysis and procedures from the field of data science to probabilistically classify, link disjointed IDs, and identify households and devices within the identity map database. In some embodiments and without limitation, the consumer profile includes PII safe first party data like the purchasing history of a consumer at a retailer, technographic data, and second party sourced datasets that provide consumer interest data, geolocation data, demographic data, personality data, media consumption data, iAB supply categorization data, digital signals, and the like. In some embodiments, and without limitation, step 506 includes correlating transactions in a consumer packaged goods space with a variety of location data, consumer interest data, technographic data, demographic data, personality data, media consumption data, and the like.

Step 508 includes targeting digital ads, promotions, offers, and digital media to consumers within the marketing and advertising space based on the newly identified ID linkages. In some embodiments, first party acquired datasets like location information from devices includes location data within a retail store, the location associated with a class of consumer-packaged goods including consumer transaction data gathered in a PII safe manner. Accordingly, in some embodiments, step 508 includes correlating the consumer profile with the class of consumer-packaged goods. In some embodiments, step 508 includes providing a value added certificate for purchasing an item at a retail store. In some embodiments, step 508 includes feeding a media file including promotional information for display in the mobile device, and other devices. In some embodiments, step 508 includes updating the consumer profile in the database using information from first and second party datasets. In some embodiments, storing the location information in the database includes classifying a user of client devices in a consumer category (e.g., client devices 110 or 210), and step 508 includes providing an advertisement associated with the consumer category for display across devices in mobile, desktop, connected TV, and the like.

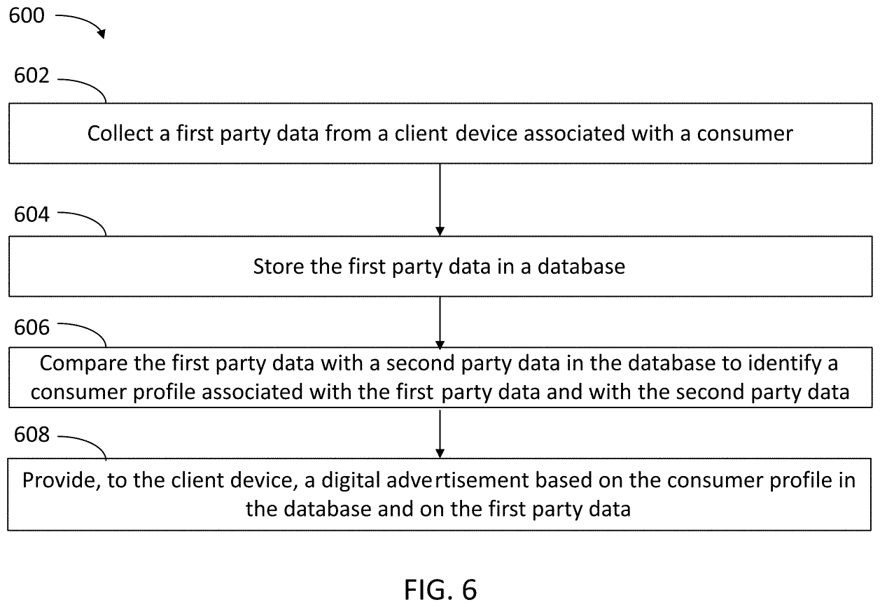

FIG. 6 is a flowchart including steps in a method 600 for providing a digital advertisement to a consumer upon identification of the consumer in a database, according to some embodiments. In some embodiments, one or more of the steps in method 600 may be performed by one or more of the devices and components illustrated in FIGS. 1 and 2. For example, in some embodiments, one or more of the steps in method 600 may be performed by a client device or a server including processors executing instructions stored in memory circuits (e.g., client devices 110 and 210, servers 130 and 230, and processors 212 and memories 220, cf. FIGS. 1, 2). In some embodiments, the memory may include a marketing engine having a management tool and an advertisement tool, and a digital identification engine having a correlation tool and a database management tool (e.g., marketing engine 240, management tool 242, advertisement tool 244, digital identification engine 246, correlation tool 248, and database management tool 249, cf. FIG. 2). In some embodiments, the server may also be communicatively coupled to a database storing digital information arranged in an identification table or any other tables and in a graph, via a network (e.g., databases 152 and 252, digital information 225, identification table 255, table 355, graph 400, and network 150, cf. FIGS. 1, 2, 3, and 4). In some embodiments, to communicate with each other and the network, the client devices and servers may execute steps consistent with method 600 using an input device, an output device, and a communications module (e.g., input device 214, output device 216, and communications module 218, cf. FIG. 2). Moreover, in some embodiments, methods consistent with the present disclosure may include at least one of the steps in method 600 performed in a different order, simultaneously, quasi-simultaneously, or overlapping in time.

Step 602 includes collecting a first party data from a client device associated with a consumer. In some embodiments, at least one of the first party data or the second party data includes a geolocation information indicative of a presence of the consumer within a radius from a retail store, and step 602 includes determining a likelihood that the geolocation information corresponds to the consumer profile. In some embodiments, at least one of the first party data or the second party data includes a loyalty identification data for the consumer in a consumer retail service network, and step 602 includes determining a likelihood that the loyalty identification data, the consumer profile, and a device code associated with the client device correspond to a same consumer. In some embodiments, at least one of the first party data or the second party data includes a device code associated with the client device, and step 602 includes determining a likelihood that the client device is used by a consumer associated with the consumer profile. In some embodiments, step 602 includes correlating at least one of an internet protocol address, an operating system version in the client device, a user agent, an application, or a website running in the client device. In some embodiments, step 602 includes pairing the first party data and the second party data within a radius of a geolocation information associated with the client device. In some embodiments, step 602 includes associating the consumer profile with a group of consumers having a household identifier.

Step 604 includes storing the first party data in a database. In some embodiments, step 604 includes storing the first party data in a first database and retrieving the second party data from a second database.

Step 606 includes comparing the first party data with a second party data in the database to identify a consumer profile associated with the first party data and with the second party data. In some embodiments, step 606 includes determining the second party data based on at least a portion of the first party data with a model trained with a data stored in the database. In some embodiments, the first party data includes a mobility data for the client device, and step 606 includes inferring the second party data with a behavioral model based on the mobility data. In some embodiments, step 606 includes receiving a purchasing data associated with the digital advertisement and with the consumer, and updating a model for comparing the first party data with the second party data based on the purchasing data. In some embodiments, step 606 includes updating the consumer profile based on the first party data and the second party data. In some embodiments, step 606 includes determining a correlation between the consumer and the consumer profile and determining a confidence level for the correlation. In some embodiments, step 606 includes receiving a third party data associated with the consumer and updating the database with the third party data to improve a likelihood that the consumer profile is associated with the consumer. In some embodiments, the client device is associated with a group of consumers, and step 606 includes selecting a consumer from the group of consumers based on the first party data and the second party data to identify the consumer profile.

Step 608 includes providing, to the client device, a digital advertisement based on the consumer profile in the database and on the first party data. In some embodiments, step 608 includes providing a value added certificate to the consumer, the value added certificate associated with a product for sale in a retailer store identified according to the first party data. In some embodiments, step 608 includes receiving a request from the client device to access a consumer network and to receive a value added certificate with the digital advertisement. In some embodiments, step 608 includes modifying a correlation between the first party data and the second party data in the database based on a purchase at a retail store, the purchase based on the digital advertisement. In some embodiments, step 608 includes collecting the second party data from a second server providing a network service to the client device. In some embodiments, step 608 includes providing a printing instruction to a printer in a retail store identified according to the first party data, the printing instruction including a printing instruction of a value added certificate for the consumer.

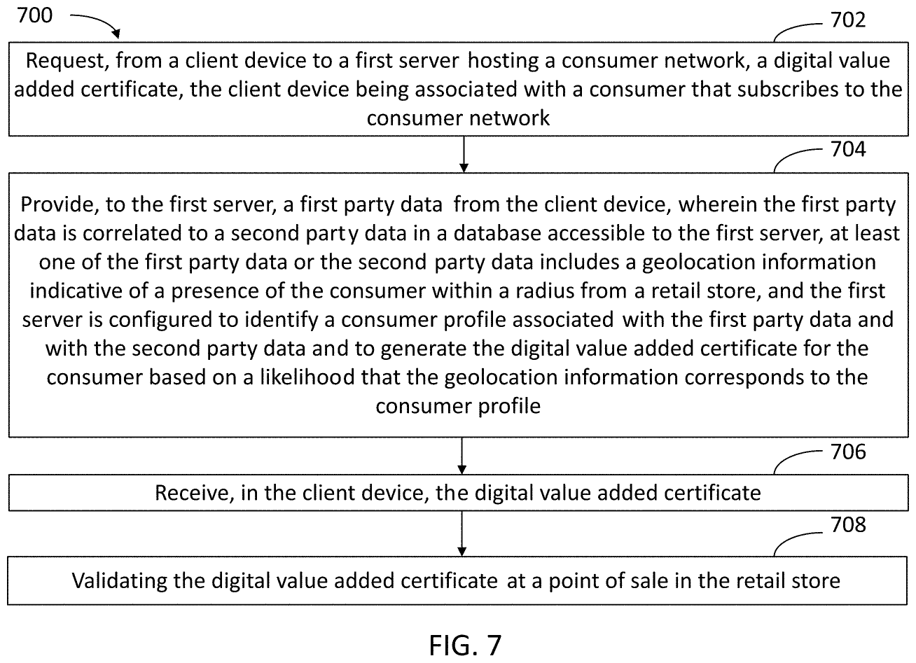

FIG. 7 is a flowchart including steps in a method 700 for requesting a digital value added certificate to a server hosting a consumer network, according to some embodiments. In some embodiments, one or more of the steps in method 700 may be performed by one or more of the devices and components illustrated in FIGS. 1 and 2. For example, in some embodiments, one or more of the steps in method 700 may be performed by a client device or a server including processors executing instructions stored in memory circuits (e.g., client devices 110 and 210, servers 130 and 230, and processors 212 and memories 220, cf. FIGS. 1, 2). In some embodiments, the memory may include a marketing engine having a management tool and an advertisement tool, and a digital identification engine having a correlation tool and a database management tool (e.g., marketing engine 240, management tool 242, advertisement tool 244, digital identification engine 246, correlation tool 248, and database management tool 249, cf. FIG. 2). In some embodiments, the server may also be communicatively coupled to a database storing digital information arranged in an identification table or any other tables and in a graph, via a network (e.g., databases 152 and 252, digital information 225, identification table 255, table 355, graph 400, and network 150, cf. FIGS. 1, 2, 3, and 4). In some embodiments, to communicate with each other and the network, the client devices and servers may execute steps consistent with method 700 using an input device, an output device, and a communications module (e.g., input device 214, output device 216, and communications module 218, cf. FIG. 2). Moreover, in some embodiments, methods consistent with the present disclosure may include at least one of the steps in method 700 performed in a different order, simultaneously, quasi-simultaneously, or overlapping in time.

Step 702 includes requesting, from a client device to a first server hosting a consumer network, a digital value added certificate, the client device being associated with a consumer that subscribes to the consumer network.

Step 704 includes providing, to the first server, a first party data from the client device. In some embodiments, the first party data is correlated to a second party data in a database accessible to the first server. In some embodiments, at least one of the first party data or the second party data includes a geolocation information indicative of a presence of the consumer within a radius from a retail store. In some embodiments, the first server is configured to identify a consumer profile associated with the first party data and with the second party data and to generate the digital value added certificate for the consumer based on a likelihood that the geolocation information corresponds to the consumer profile. In some embodiments, step 704 includes providing at least one of an internet protocol address, an operating system version in the client device, a user agent, an application, or a website running in the client device. In some embodiments, step 704 further includes authorizing the first server to pair the first party data and the second party data within a radius of a geolocation information associated with the client device. In some embodiments, step 704 includes selecting the consumer profile from a group of consumers having a household identifier, the group of consumers provided by the first server based on a correlation of the first party data and the second party data. In some embodiments, step 704 includes authorizing the first server to determine the second party data based on at least a portion of the first party data with a model trained with a data stored in the database. In some embodiments, step 704 includes providing a mobility data for the client device to the first server, wherein the first server is configured to infer the second party data with a behavioral model based on the mobility data. In some embodiments, step 704 includes authorizing the first server to update the consumer profile based on the first party data and the second party data. In some embodiments, step 704 includes authorizing the first server to determine a correlation between the consumer and the consumer profile and determining a confidence level for the correlation. In some embodiments, step 704 includes authorizing a second server to provide the second party data to the first server. In some embodiments, step 704 includes authorizing the first server to update the database with the second party data to improve a likelihood that the consumer profile is associated with the consumer. In some embodiments, step 704 includes authorizing the first server to modify a correlation between the first party data and the second party data in the database based on a purchase at a retail store associated with the digital value added certificate. In some embodiments, the first party data includes an information retrieved by the first server from an application installed in the client device, and step 704 includes authorizing the first server to retrieve the information. In some embodiments, step 704 includes accessing a second server hosting a social network, and authorizing the second server to provide the second party data to the first server, wherein the second party data includes data associated to a social network activity of the consumer. In some embodiments, step 704 includes authorizing the first server to retrieve the second party data from a second database.

Step 706 includes receiving, in the client device, the digital value added certificate.

Step 708 includes validating the digital value added certificate at a point of sale in the retail store. In some embodiments, step 708 includes validating the digital value added certificate to the first server. In some embodiments, at least one of the first party data or the second party data includes a loyalty identification data for the consumer in a consumer retail service network, and step 708 includes validating the loyalty identification data to the first server with the client device. In some embodiments, at least one of the first party data or the second party data includes a device code associated with the client device, and step 708 includes validating to the first server that the client device is used by a consumer associated with the consumer profile. In some embodiments, step 708 includes providing, to the first server, a purchasing data associated with the digital value added certificate, wherein the first server is configured to update a model for comparing the first party data with the second party data based on the purchasing data. In some embodiments, the digital value added certificate is associated with a product for sale in the retailer store, and step 708 includes requesting a second digital value added certificate for a second product for sale in the retailer store. In some embodiments, step 708 includes providing a printing instruction to a printer in the retail store, the printing instruction including a printing instruction of the digital value added certificate.

### Hardware Overview

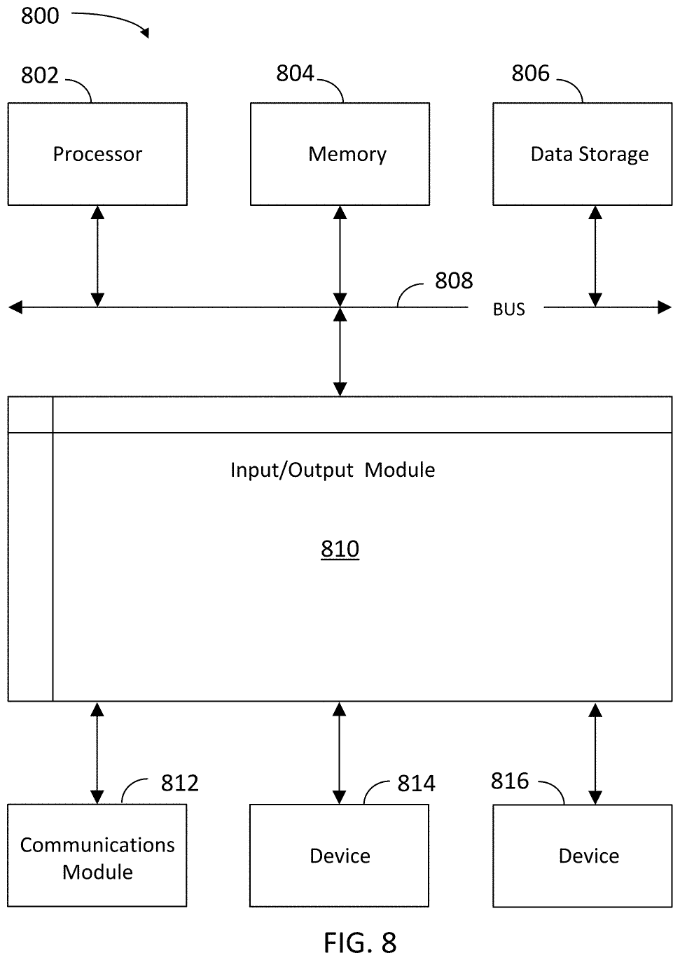

FIG. 8 is a block diagram illustrating an example computer system 800 with which the client and network device of FIG. 1 and the methods of FIGS. 5-7 can be implemented. In certain aspects, computer system 800 may be implemented using hardware or a combination of software and hardware, either in a dedicated network device, or integrated into another entity, or distributed across multiple entities.

Computer system 800 (e.g., client device 110 and server 130) includes a bus 808 or other communication mechanism for communicating information, and a processor 802 (e.g., processors 212) coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program consumer products, e.g., one or more modules of computer program instructions encoded on a computer-readable medium for execution by, or to control the operation of, the computer system 800, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. Input/output module 810 can be any input/output module. Exemplary input/output modules 810 include data ports such as USB ports. The input/output module 810 is configured to connect to a communications module 812. Exemplary communications modules 812 (e.g., communications modules 218) include networking interface cards, such as Ethernet cards and modems. In certain aspects, input/output module 810 is configured to connect to a plurality of devices, such as an input device 814 (e.g., input device 114) and/or an output device 816 (e.g., output device 116). Exemplary input devices 814 include a keyboard and a pointing device, e.g., a mouse or a trackball, by which a consumer can provide input to the computer system 800. Other kinds of input devices 814 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 816 include display devices, such as an LCD (liquid crystal display) monitor, for displaying information to the consumer.

According to one aspect of the present disclosure, the client device 110 and server 130 can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data network device, or that includes a middleware component, e.g., an application network device, or that includes a front-end component, e.g., a client computer having a graphical consumer interface or a Web browser through which a consumer can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and network devices. A client and network device are generally remote from each other and typically interact through a communication network. The relationship of client and network device arises by virtue of computer programs running on the respective computers and having a client-network device relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires forming bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

### RECITATION OF EMBODIMENTS

Embodiments disclosed herein include:

I. A computer-implemented method that includes collecting a first party data from a client device associated with a consumer and storing the first party data in a database. The computer-implemented method also includes comparing the first party data with a second party data in the database to identify a consumer profile associated with the first party data and with the second party data and providing, to the client device, a digital advertisement based on the consumer profile in the database and on the first party data.

II. A computer-implemented method that includes requesting, from a client device to a first server hosting a consumer network, a digital value added certificate, the client device being associated with a consumer that subscribes to the consumer network. The computer-implemented method also includes providing, to the first server, a first party data from the client device. The first party data is correlated to a second party data in a database accessible to the first server and at least one of the first party data or the second party data comprises a geolocation information indicative of a presence of the consumer within a radius from a retail store. The first server is configured to identify a consumer profile associated with the first party data and with the second party data and to generate the digital value added certificate for the consumer based on a likelihood that the geolocation information corresponds to the consumer profile. The computer-implemented method also includes receiving, in the client device, the digital value added certificate and validating the digital value added certificate at a point of sale in the retail store.

III. A system that includes a memory storing instructions and a processor. The processor is configured to execute at least one instruction and cause the system to collect a first party data from a client device associated with a consumer and to store the first party data in a database. The one or more processors also execute instructions to compare the first party data with a second party data in the database to identify a consumer profile associated with the first party data and with the second party data, and to provide, to the client device, a digital advertisement based on the consumer profile in the database and on the first party data.

Additionally to embodiments I, II, and III, embodiments consistent with the present disclosure may include any one or more of the following elements, in any combination.

Element 1, wherein at least one of the first party data or the second party data comprises a geolocation information indicative of a presence of the consumer within a radius from a retail store, and comparing the first party data with the second party data comprises determining a likelihood that the geolocation information corresponds to the consumer profile. Element 2, wherein at least one of the first party data or the second party data comprises a loyalty identification data for the consumer in a consumer retail service network, and comparing the first party data with the second party data comprises determining a likelihood that the loyalty identification data, the consumer profile, and a device code associated with the client device correspond to a same consumer. Element 3, wherein at least one of the first party data or the second party data comprises a device code associated with the client device, and comparing the first party data with the second party data comprises determining a likelihood that the client device is used by a consumer associated with the consumer profile. Element 4, wherein comparing the first party data with the second party data comprises correlating at least one of an internet protocol address, an operating system version in the client device, a user agent, an application or a website running in the client device. Element 5, wherein comparing the first party data with the second party data comprises pairing the first party data and the second party data within a radius of a geolocation information associated with the client device. Element 6, wherein comparing the first party data with the second party data in the database comprises associating the consumer profile with a group of consumers having a household identifier. Element 7, further comprising determining the second party data based on at least a portion of the first party data with a model trained with a data stored in the database. Element 8, wherein the first party data comprises a mobility data for the client device, further comprising inferring the second party data with a behavioral model based on the mobility data. Element 9, further comprising receiving a purchasing data associated with the digital advertisement and with the consumer, and updating a model for comparing the first party data with the second party data based on the purchasing data. Element 10, further comprising updating the consumer profile based on the first party data and the second party data. Element 11, wherein comparing the first party data with the second party data comprises determining a correlation between the consumer and the consumer profile and determining a confidence level for the correlation. Element 12, further comprising receiving a third party data associated with the consumer and updating the database with the third party data to improve a likelihood that the consumer profile is associated with the consumer. Element 13, wherein providing the digital advertisement comprises providing a value added certificate to the consumer, the value added certificate associated with a product for sale in a retailer store identified according to the first party data. Element 14, further comprising receiving a request from the client device to access a consumer network and to receive a value added certificate with the digital advertisement. Element 15, further comprising modifying a correlation between the first party data and the second party data in the database based on a purchase at a retail store, the purchase based on the digital advertisement. Element 16, wherein the client device is associated with a group of consumers, further comprising selecting a consumer from the group of consumers based on the first party data and the second party data to identify the consumer profile. Element 17, further comprising collecting the second party data from a second server providing a network service to the client device. Element 18, wherein storing the first party data in the database comprises storing the first party data in a first database and retrieving the second party data from a second database. Element 19, wherein providing the digital advertisement based on the consumer profile and on the first party data comprises providing a printing instruction to a printer in a retail store identified according to the first party data, the printing instruction comprising a printing instruction of a value added certificate for the consumer.

Element 20, wherein at least one of the first party data or the second party data comprises a geolocation information indicative of a presence of the consumer within a radius from a retail store, and to compare the first party data with the second party data the one or more processors execute instructions to determine a likelihood that the geolocation information corresponds to the consumer profile. Element 21, wherein at least one of the first party data or the second party data comprises a loyalty identification data for the consumer in a consumer retail service network, and to compare the first party data with the second party data the one or more processors execute instructions to determine a likelihood that the loyalty identification data, the consumer profile, and a device code associated with the client device correspond to a same consumer. Element 22, wherein at least one of the first party data or the second party data comprises a device code associated with the client device, and to compare the first party data with the second party data the one or more processors execute instructions to determine a likelihood that the client device is used by a consumer associated with the consumer profile. Element 23, wherein to compare the first party data with the second party data the one or more processors execute instructions to correlate at least one of an internet protocol address, an operating system version in the client device, a user agent, an application or a website running in the client device. Element 24, wherein to compare the first party data with the second party data the one or more processors execute instructions to pair the first party data and the second party data within a radius of a geolocation information associated with the client device. Element 25, wherein to compare the first party data with the second party data in the database the one or more processors execute instructions to associate the consumer profile with a group of consumers having a household identifier. Element 26, wherein the one or more processors further execute instructions to determine the second party data based on at least a portion of the first party data with a model trained with a data stored in the database. Element 27, wherein the first party data comprises a mobility data for the client device, and wherein the one or more processors further execute instructions to infer the second party data with a behavioral model based on the mobility data. Element 28, wherein the one or more processors further execute instructions to receive a purchasing data associated with the digital advertisement and with the consumer, and to update a model for comparing the first party data with the second party data based on the purchasing data. Element 29, wherein the one or more processors further execute instructions to update the consumer profile based on the first party data and the second party data. Element 30, wherein to compare the first party data with the second party data the one or more processors execute instructions to determine a correlation between the consumer and the consumer profile and determining a confidence level for the correlation. Element 31, wherein the one or more processors further execute instructions to receive a third party data associated with the consumer and to update the database with the third party data to improve a likelihood that the consumer profile is associated with the consumer. Element 32, wherein to provide the digital advertisement the one or more processors execute instructions to provide a value added certificate to the consumer, the value added certificate associated with a product for sale in a retailer store identified according to the first party data. Element 33, wherein the one or more processors further execute instructions to receive a request from the client device to access a consumer network and to receive a value added certificate with the digital advertisement. Element 34, wherein the one or more processors further execute instructions to modify a correlation between the first party data and the second party data in the database based on a purchase at a retail store, the purchase based on the digital advertisement. Element 35, wherein the client device is associated with a group of consumers, and the one or more processors further execute instructions to select a consumer from the group of consumers based on the first party data and the second party data to identify the consumer profile. Element 36, wherein the one or more processors execute instructions to collect the second party data from a second server providing a network service to the client device. Element 37, wherein to store the first party data in the database the one or more processors execute instructions to store the first party data in a first database and to retrieve the second party data from a second database. Element 38, wherein to provide the digital advertisement based on the consumer profile and on the first party data the one or more processors execute instructions to provide a printing instruction to a printer in a retail store identified according to the first party data, the printing instruction comprising a printing instruction of a value added certificate for the consumer.

Element 39, further comprising validating the digital value added certificate to the first server. Element 40, wherein at least one of the first party data or the second party data comprises a loyalty identification data for the consumer in a consumer retail service network, further comprising validating the loyalty identification data to the first server with the client device. Element 41, wherein at least one of the first party data or the second party data comprises a device code associated with the client device, further comprising validating to the first server that the client device is used by a consumer associated with the consumer profile. Element 42, wherein providing the first party data comprises providing at least one of an internet protocol address, an operating system version in the client device, a user agent, an application or a website running in the client device. Element 43, further comprising authorizing the first server to pair the first party data and the second party data within a radius of a geolocation information associated with the client device. Element 44, further comprising selecting the consumer profile from a group of consumers having a household identifier, the group of consumers provided by the first server based on a correlation of the first party data and the second party data. Element 45, further comprising authorizing the first server to determine the second party data based on at least a portion of the first party data with a model trained with a data stored in the database. Element 46, wherein providing the first party data comprises providing a mobility data for the client device to the first server, wherein the first server is configured to infer the second party data with a behavioral model based on the mobility data. Element 47, further comprising providing, to the first server, a purchasing data associated with the digital value added certificate, wherein the first server is configured to update a model for comparing the first party data with the second party data based on the purchasing data. Element 48, further comprising authorizing the first server to update the consumer profile based on the first party data and the second party data. Element 49, further comprising authorizing the first server to determine a correlation between the consumer and the consumer profile and determining a confidence level for the correlation. Element 50, further comprising authorizing a second server to provide the second party data to the first server. Element 51, wherein the digital value added certificate is associated with a product for sale in the retailer store, further comprising requesting a second digital value added certificate for a second product for sale in the retailer store. Element 52, further comprising authorizing the first server to update the database with the second party data to improve a likelihood that the consumer profile is associated with the consumer. Element 53, further comprising authorizing the first server to modify a correlation between the first party data and the second party data in the database based on a purchase at a retail store associated with the digital value added certificate. Element 54, wherein the first party data comprises an information retrieved by the first server from an application installed in the client device, further comprising authorizing the first server to retrieve the information. Element 55, further comprising accessing a second server hosting a social network, and authorizing the second server to provide the second party data to the first server, wherein the second party data comprises data associated to a social network activity of the consumer. Element 56, further comprising authorizing the first server to retrieve the second party data from a second database. Element 57, further comprising providing a printing instruction to a printer in the retail store, the printing instruction comprising a printing instruction of the digital value added certificate.

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The subject technology is illustrated, for example, according to various aspects in the below claims. Various examples of aspects of the subject technology are described in the claims. These are provided as examples, and do not limit the subject technology. The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A computer-implemented method, comprising:
collecting a first party data from a client device associated with a consumer;
storing the first party data in a database;
comparing the first party data with a second party data in the database to identify a consumer profile associated with the first party data and with the second party data; and
providing, to the client device, a digital advertisement based on the consumer profile in the database and on the first party data.

2. The computer-implemented method of claim 1, wherein at least one of the first party data or the second party data comprises a geolocation information indicative of a presence of the consumer within a radius from a retail store, and comparing the first party data with the second party data comprises determining a likelihood that the geolocation information corresponds to the consumer profile.

3. The computer-implemented method of claim 1, wherein at least one of the first party data or the second party data comprises a loyalty identification data for the consumer in a consumer retail service network, and comparing the first party data with the second party data comprises determining a likelihood that the loyalty identification data, the consumer profile, and a device code associated with the client device correspond to a same consumer.

4. The computer-implemented method of claim 1, wherein at least one of the first party data or the second party data comprises a device code associated with the client device, and comparing the first party data with the second party data comprises determining a likelihood that the client device is used by a consumer associated with the consumer profile.

5. The computer-implemented method of claim 1, wherein comparing the first party data with the second party data comprises correlating at least one of an internet protocol address, an operating system version in the client device, a user agent, an application or a website running in the client device.

6. The computer-implemented method of claim 1, wherein comparing the first party data with the second party data comprises pairing the first party data and the second party data within a radius of a geolocation information associated with the client device.

7. The computer-implemented method of claim 1, wherein comparing the first party data with the second party data in the database comprises associating the consumer profile with a group of consumers having a household identifier.

8. The computer-implemented method of claim 1, further comprising determining the second party data based on at least a portion of the first party data with a model trained with a data stored in the database.

9. The computer-implemented method of claim 1, wherein the first party data comprises a mobility data for the client device, further comprising inferring the second party data with a behavioral model based on the mobility data.

10. The computer-implemented method of claim 1, further comprising receiving a purchasing data associated with the digital advertisement and with the consumer, and updating a model for comparing the first party data with the second party data based on the purchasing data.

11. The computer-implemented method of claim 1, further comprising updating the consumer profile based on the first party data and the second party data.

12. The computer-implemented method of claim 1, wherein comparing the first party data with the second party data comprises determining a correlation between the consumer and the consumer profile and determining a confidence level for the correlation.

13. The computer-implemented method of claim 1, further comprising receiving a third party data associated with the consumer and updating the database with the third party data to improve a likelihood that the consumer profile is associated with the consumer.

14. The computer-implemented method of claim 1, wherein providing the digital advertisement comprises providing a value added certificate to the consumer, the value added certificate associated with a product for sale in a retailer store identified according to the first party data.

15. The computer-implemented method of claim 1, further comprising receiving a request from the client device to access a consumer network and to receive a value added certificate with the digital advertisement.

16. The computer-implemented method of claim 1, further comprising modifying a correlation between the first party data and the second party data in the database based on a purchase at a retail store, the purchase based on the digital advertisement.

17. The computer-implemented method of claim 1, wherein the client device is associated with a group of consumers, further comprising selecting a consumer from the group of consumers based on the first party data and the second party data to identify the consumer profile.

18. The computer-implemented method of claim 1, further comprising collecting the second party data from a second server providing a network service to the client device.

19. The computer-implemented method of claim 1, wherein storing the first party data in the database comprises storing the first party data in a first database and retrieving the second party data from a second database.

20. The computer-implemented method of claim 1, wherein providing the digital advertisement based on the consumer profile and on the first party data comprises providing a printing instruction to a printer in a retail store identified according to the first party data, the printing instruction comprising a printing instruction of a value added certificate for the consumer.

21.-60. (canceled)
